(19) United States
(12) Patent Application Publication
(10) Pub. No.: US 2016/0365646 A1
(43) Pub. Date: Dec. 15, 2016

(54) ARRAY ANTENNA DEVICE

(71) Applicant: KABUSHIKI KAISHA TOSHIBA, Minato-ku (JP)

(72) Inventors: Makoto HIGAKI, Tokyo (JP); Koh HASHIMOTO, Yokohama (JP); Manabu MUKAI, Yokohama (JP)

(73) Assignee: KABUSHIKI KAISHA TOSHIBA, Minato-ku (JP)

(21) Appl. No.: 15/245,683

(22) Filed: Aug. 24, 2016

Related U.S. Application Data
(63) Continuation of application No. PCT/JP2014/076291, filed on Oct. 1, 2014.

(30) Foreign Application Priority Data
Feb. 27, 2014 (JP) 2014-036906

(51) Int. Cl. H01Q 21/06; H01Q 9/04; H01Q 21/24

(52) U.S. Cl. CPC H01Q 21/065; H01Q 21/24; H01Q 9/0457

(57) ABSTRACT

According to one embodiment, an array antenna device includes first and second substrates. The first substrate includes first radiating elements, and first lines connecting a first feed point to the first elements by lines of equal length, respectively, such that the first elements form a linearly polarized wave in a first direction. The second substrate includes second radiating elements, and second lines connecting a second feed point to the second elements by lines of equal length, which is the same as the first lines, respectively, such that the second elements form a linearly polarized wave in a second direction orthogonal to the first direction.

### CROSS REFERENCE TO RELATED APPLICATIONS

This application is a Continuation Application of PCT Application No. PCT/JP2014/076291, filed Oct. 1, 2014 and based upon and claiming the benefit of priority from Japanese Patent Application No. 2014-036906, filed Feb. 27, 2014, the entire contents of all of which are incorporated herein by reference.

### FIELD

Embodiments described herein relate generally to an array antenna device.

### BACKGROUND

In an antenna that transmits radio waves to and receives radio waves from a communications satellite, a sidelobe level is required to be suppressed to a certain level under the ITU-R standard, etc. To satisfy the requirement, an array antenna that includes radiating elements arranged in an array on a rectangular planar substrate and is designed to form a linearly polarized wave by keeping a certain angle with respect to the sides of the planar substrate is known.

In order to form a linearly polarized wave, the radiating elements should be connected to a feed point by a pattern of lines of equal length, respectively. In particular, in the case of forming a linearly polarized wave by keeping a certain angle with respect to the sides of the planar substrate, a method of aligning a direction of connection of feed lines to the radiating elements with a direction of a linearly polarized wave to be formed may be applied.

In the method of forming a linearly polarized wave by keeping a certain angle as described above, however, it is necessary to adjust lengths of the feed lines by making the feed lines meander in order to obtain a pattern of lines of equal length. In this case, characteristics of meandering parts of the feed lines vary according to a frequency of a transmission signal. More specifically, since some parts of the feed lines are bent at an acute angle, some feed lines may be close to other feed lines or radiating elements. In such an area where conductors are close to each other, electromagnetic interference occurs and quality of antenna deteriorates. Further, since the feed lines meander in the above method, there are problems that adjacent feed lines are coupled to each other, the feed lines should be arranged densely, etc.

### BRIEF DESCRIPTION OF THE DRAWINGS

FIG. 1 is an exploded perspective view showing an array antenna device of a first embodiment.

FIG. 2 shows a case of using a waveguide type magic-T phase feed circuit in the array antenna device of the first embodiment.

FIG. 3 is an exploded perspective view showing an array antenna device of a second embodiment.

FIG. 4 shows a case of using a waveguide type magic-T phase feed circuit in the array antenna device of the second embodiment.

### DETAILED DESCRIPTION

Various embodiments will be described hereinafter with reference to the accompany drawings.

In general, according to one embodiment, there are provided an array antenna device comprises: a first substrate comprising a first feed point; a second substrate provided under the first substrate and comprising a second feed point; and a 180° hybrid circuit which feeds the first feed point and the second feed point with a phase difference of zero or 180°. The first substrate comprises: a first dielectric layer; a first radiating element array formed by arranging first radiating elements in an array on the first dielectric layer; first feed lines provided on the first dielectric layer and connecting the first feed point to the first radiating elements by a pattern of lines of equal length, respectively, such that the first radiating elements form a linearly polarized wave in a first polarization direction; a first ground conductor layer provided under the first dielectric layer; and a second dielectric layer provided under the first ground conductor layer. The second substrate comprises: a third dielectric layer located under the second dielectric layer; a second radiating element array formed by arranging second radiating elements in an array on the third dielectric layer such that the second radiating elements are opposed to the first radiating elements, respectively; second feed lines provided on the third dielectric layer and connecting the second feed point to the second radiating elements by a pattern of lines of equal length, which is the same as the pattern of the first feed lines, respectively, such that the second radiating elements form a linearly polarized wave in a second polarization direction orthogonal to the first polarization direction; and a second ground conductor layer provided under the third dielectric layer. The first ground conductor layer has openings in positions opposed to the first radiating elements and the second radiating elements. Connecting portions of the first feed lines to the first radiating elements are formed in a direction orthogonal to a direction of connecting portions of the second feed lines to the second radiating elements.

It should be noted that structures common in embodiments are denoted by the same reference numbers or symbols and overlapping explanations are omitted. Each figure is an exemplary diagram of an embodiment to prompt understanding of the embodiment. The shapes, dimensions or ratios in the drawings may differ from those of the actual device, but they can be appropriately changed in consideration of the explanation below and known art.

### First Embodiment

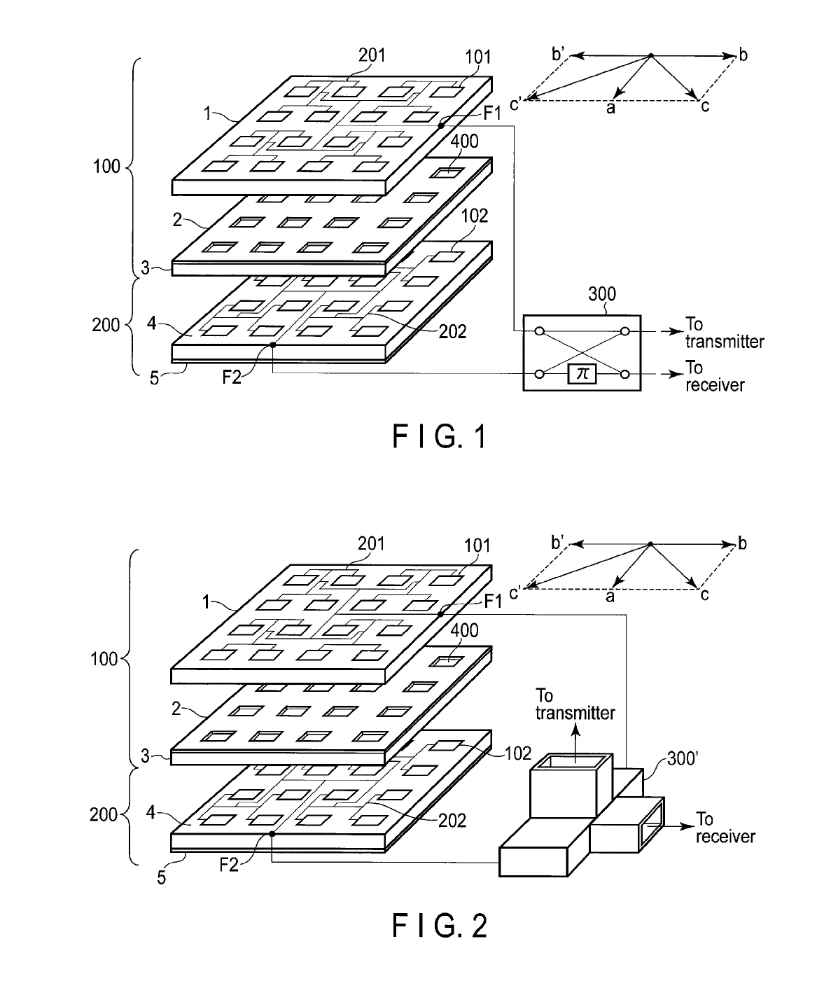

FIG. 1 is an exploded perspective view of an array antenna device of a first embodiment. In FIG. 1, the array antenna device comprises a first substrate 100, a second substrate 200 provided under the first substrate 100 and a 180° hybrid circuit 300 connected to the first substrate 100 and the second substrate 200.

The first substrate 100 comprises a first dielectric layer 1, a first ground conductor layer 2 provided under the first dielectric layer 1 and a second dielectric layer 3 provided under the first ground conductor layer 2.

On a surface of the first dielectric layer 1, first radiating elements 101 are arranged in an array in two directions orthogonal to each other to form a first radiating element array. On the surface of the first dielectric layer 1, first feed lines 201 are also formed to connect a first feed point F1 provided at an end of the surface to the first radiating elements 101 by equal length.

The second substrate 200 comprises a third dielectric layer 4 and a second ground conductor layer 5 provided under the third dielectric layer 4. On a surface of the third dielectric layer 4, second radiating elements 102 are arranged in an array in positions opposed to the first radiating elements 101, respectively, to form a second radiating element array. On a surface of the third dielectric layer 4, second feed lines 202 are also formed to connect a second feed point F2 provided at an end of the surface to the second radiating elements 102 by equal length.

The structure of each of the first substrate 100 and the second substrate 200 is hereinafter described in detail.

On the first substrate 100, the first radiating element array is formed by, for example, evaporating a metal film onto the surface of the first dielectric layer 1 and then patterning and etching the first radiating elements 101. Each first radiating element 101 is rectangular in FIG. 1, but the shape is not limited to a rectangle and may be, for example, a circle.

As described above, the first feed lines 201 are provided on the surface of the first dielectric layer 1 and connect the first feed point F1 to the first radiating elements 101 by a pattern of lines of equal length, respectively, such that the first radiating element array forms a linearly polarized wave in a first polarization direction. The pattern of lines of equal length can be implemented by forming the lines into a right-angular branching layout by, for example, etching, together with the first radiating element array. If the feed lines are formed into a branching layout to have equal length, the feed lines do not include a part bent at an acute angle and thus the feed lines are not located close to each other. As a result, quality deterioration of antenna caused by electromagnetic interference between the feed lines can be prevented.

In the above structure, the first feed lines 201 are formed on the surface of the first dielectric layer 1 together with the first radiating elements 101, but the first dielectric layer 1 may be divided into layers and the first feed lines 201 may be formed between these layers. In this case, a pattern of the first feed lines 201 is designed to have feed ends extended under the centers of the first radiating elements 101, respectively, such that they are electromagnetically coupled under the first radiating elements 101.

The first ground conductor layer 2 provided under the first dielectric layer 1 functions as a ground of the first feed lines 201 and prevents electromagnetic interference between the first feed lines 201 and the second feed lines 202. The first ground conductor layer 2 has openings 400 in positions opposed to the first radiating elements 101 and the second radiating elements 102. The openings 400 are provided to combine a linearly polarized wave radiated from the first radiating element array with a linearly polarized wave radiated from the second radiating. element array, and can be formed by, for example, etching.

The second dielectric layer 3 provided under the first ground conductor layer 2 is a layer to insulate the first ground conductor layer 2 from the second radiating elements 102 and the second feed lines 202 formed on the second substrate 200.

On the second substrate 200, the second radiating element array is formed by, for example, evaporating a metal film onto the surface of the third dielectric layer 4 and then patterning and etching the second radiating elements in the same manner as the first radiating element array. Each second radiating element 102 is rectangular in FIG. 1, but the shape is not limited to a rectangle and may be, for example, a circle.

As described above, the second feed lines 202 are provided on the surface of the third dielectric layer 4 and connect the second feed point F2 to the second radiating elements 102 by a pattern of lines of equal length, which is the same as the pattern of the first feed lines 201, respectively, such that the second radiating element array forms a linearly polarized wave in a second polarization direction orthogonal to the first polarization direction. More specifically, when viewed from a direction perpendicular to the substrates, the first feed lines 201 and the second feed lines 202 are formed such that a direction of lines connected to the first radiating elements 101 is orthogonal to a direction of lines connected to the second radiating elements 102 which are opposed to the first radiating elements 101. The pattern of lines of equal length can be implemented by forming the lines into a right-angular branching layout by, for example, etching, together with the second radiating element array. As described above, quality deterioration of antenna can be prevented by forming the feed lines into a branching layout to have equal length.

In the above structure, the second feed lines 202 are formed on the surface of the third dielectric layer 4 together with the second radiating elements 102, but the third dielectric layer 4 may be divided into layers and the second feed lines 202 may be formed between these layers. In this case, a pattern of the second feed lines 202 is designed to have feed ends extended under the centers of the second radiating elements 102, respectively, such that they are electromagnetically coupled under the second radiating elements 102.

The second ground conductor layer 5 provided under the third dielectric layer 4 functions as a ground of the second feed lines 202.

Next, a structure of a feed system is described.

Connecting portions of the first feed lines 201 to the first radiating elements 101 are formed in the direction orthogonal to the direction of connecting portions of the second feed lines 202 to the second radiating elements 102. The first feed point F1 and the second feed point F2 are connected to output terminals of the 180° hybrid circuit 300, respectively, and are fed with a phase difference of zero or 180°. The 180° hybrid circuit 300 has two input terminals and two output terminals. If a signal is input to one of the input terminals, the 180° hybrid circuit 300 outputs in-phase signals from the two output terminals. If a signal is input to the other of the input terminals, the 180° hybrid circuit 300 outputs signals having a phase difference of 180°, i.e., out-of-phase signals from the two output terminals.

In the first embodiment, a transmitter and a receiver are connected to the two input terminals, respectively, but they are not shown in FIG. 1. A signal output from the transmitter passes through the 180° hybrid circuit 300 and in-phase signals of the same amplitude are distributed to the first feed point F1 and the second feed point F2. In contrast, if a signal is input to the input terminal to which the receiver is connected, out-of-phase signals of the same amplitude are distributed to the first feed point F1 and the second feed point F2. If in-phase signals of the same amplitude are input to the 180° hybrid circuit 300 from the first feed point F1 and the second feed point F2, a signal is output to the input terminal to which the transmitter is connected but is not output to the input terminal to which the receiver is connected because of reversibility. If signals of a phase difference of 180° and the same amplitude are input to the 180° hybrid circuit 300 from the first feed point F1 and the second feed point F2, a signal is output to the input terminal to which the receiver is connected but is not output to the input terminal to which the transmitter is connected. That is, if the connecting terminals of the transmitter and the receiver to the 180° hybrid circuit 300 are interchanged, reverse signal conditioning can be executed.

As the 180° hybrid circuit 300, for example, a magic-T phase feed circuit can be used. The magic-T phase feed circuit may be either a waveguide type magic-T phase feed circuit 300′ or a magic-T phase feed circuit that can be formed on a substrate using a microstrip line and a slot line. Various well-known magic-T phase feed circuits can be used in place of the magic-T phase feed circuit as appropriate.

FIG. 2 shows a case of using the magic-T phase feed circuit in the array antenna device of the first embodiment. In the waveguide type magic-T phase feed circuit 300′ of the present embodiment, if a wireless signal is input to a port on the transmitter side connected to a wide wall surface of the waveguide connected to the first and second feed lines 201 and 202, out-of-phase wireless signals are output to both the feed lines. In contrast, in-phase components of a signal obtained by combining wireless signals input from the first and second feed lines 201 and 202 are output to a port on the receiver side connected to a narrow wall surface of the waveguide connected to the first and second feed lines 201 and 202. If the connecting terminals of the transmitter and the receiver are interchanged with each other, a wireless signal input from the transmitter transmits in-phase wireless signals to the first and second feed lines 201 and 202, and out-of-phase wireless signal components input from the first and second feed lines 201 and 202 to the magic-T phase feed circuit are output to the receiver side.

The operation of the array antenna device of the first embodiment is hereinafter described.

As described above, a length of a line from the first feed point F1 to each of the first radiating elements 101 is equal to a length of a line from the second feed point F2 to each of the second radiating elements 102. Further, when viewed from the direction perpendicular to the substrates, the first feed lines 201 and the second feed lines 202 are formed such that the direction of lines connected to the first radiating elements 101 is orthogonal to the direction of lines connected to the second radiating elements 102 which are opposed to the first radiating elements 101.

Therefore, if the 180° hybrid circuit 300 feeds the first radiating elements 101 and the second radiating elements 102 in phase with each other or with a phase difference of 180°, two polarized waves orthogonal to each other are combined into a polarized wave at an angle of 45° with respect to each polarized wave and radiated in the direction perpendicular to the substrates.

More specifically, for example, it is assumed that in-phase signals are input to the first feed lines 201 and the second feed lines 202 when a signal is input from the transmitter to the 180° hybrid circuit 300. At this time, it is also assumed that a linearly polarized wave in a direction shown by arrow a in FIG. 1 is radiated from the first radiating element array and a linearly polarized wave in a direction shown by arrow b in FIG. 1 is radiated from the second radiating element array. In this case, electric and magnetic fields corresponding to the two polarized waves are combined and a linearly polarized wave having a plane of vibration in a direction shown by arrow c in FIG. 1 is radiated in the direction perpendicular to the substrates. In contrast, out-of-phase signal components input from the first feed lines 201 and the second feed lines 202 are output to the terminal on the receiver side. This means that the first radiating element array and the second radiating element array receive linearly polarized electromagnetic waves having planes of vibration in directions shown by arrows a and b′ in FIG. 1, respectively.

Next, a difference between a case of feeding the first feed point F1 and the second feed point F2 with a phase difference of 180° and a case of feeding these feed points in phase with each other is described. For example, in the case of feeding the second feed point F2 with a phase difference of 180° from the first feed point F1, the direction of the plane of vibration of the polarized wave radiated from the second radiating elements 102 is reversed in comparison with the case of feeding the second feed point F2 in phase with the first feed point F1. That is, as shown in FIG. 1, the direction of the plane of vibration of the polarized wave radiated from the second radiating elements 102 is changed from the direction of arrow b to the opposite direction of arrow b′. In this case, electric and magnetic fields corresponding to the two polarized waves are combined and a linearly polarized wave having a plane of vibration in a direction shown by arrow c′ in FIG. 1 is radiated in the direction perpendicular to the substrates. In this case, the receiver receives the linearly polarized wave having the plane of vibration in the direction of arrow c.

As is obvious from the above description, the array antenna device of the first embodiment can radiate a polarized wave having a plane of vibration at an angle of 45° with respect to the connection direction of the feed lines to the radiating elements. In other words, the feed lines can he connected or coupled to the radiating elements in the direction at an angle of 45° with respect to the direction of the plane of vibration of the radiated polarized wave. Therefore, for example, in the case where each radiating element is rectangular, a linearly polarized wave at a desired angle can be radiated without forming the radiating elements at an angle of 45° on the surface of the dielectric layer. Furthermore, intervals between the radiating elements can be reduced in comparison with the case of forming rectangular radiating elements at an angle of 45° with respect to the substrates. Moreover, sufficient space to form lines can be provided without reducing intervals between the radiating elements in comparison with the case of forming rectangular radiating elements at an angle of 45° with respect to the substrates.

In addition, the array antenna device of the first embodiment can change a direction of a plane of vibration of a polarized wave depending on whether it is used for transmission or reception by interchanging the terminals of the 180° hybrid circuit 300 connecting with the transmitter and the receiver. Therefore, the array antenna device of the first embodiment can easily switch the polarization direction even if the antenna is large in size and difficult to rotate.

### Second Embodiment

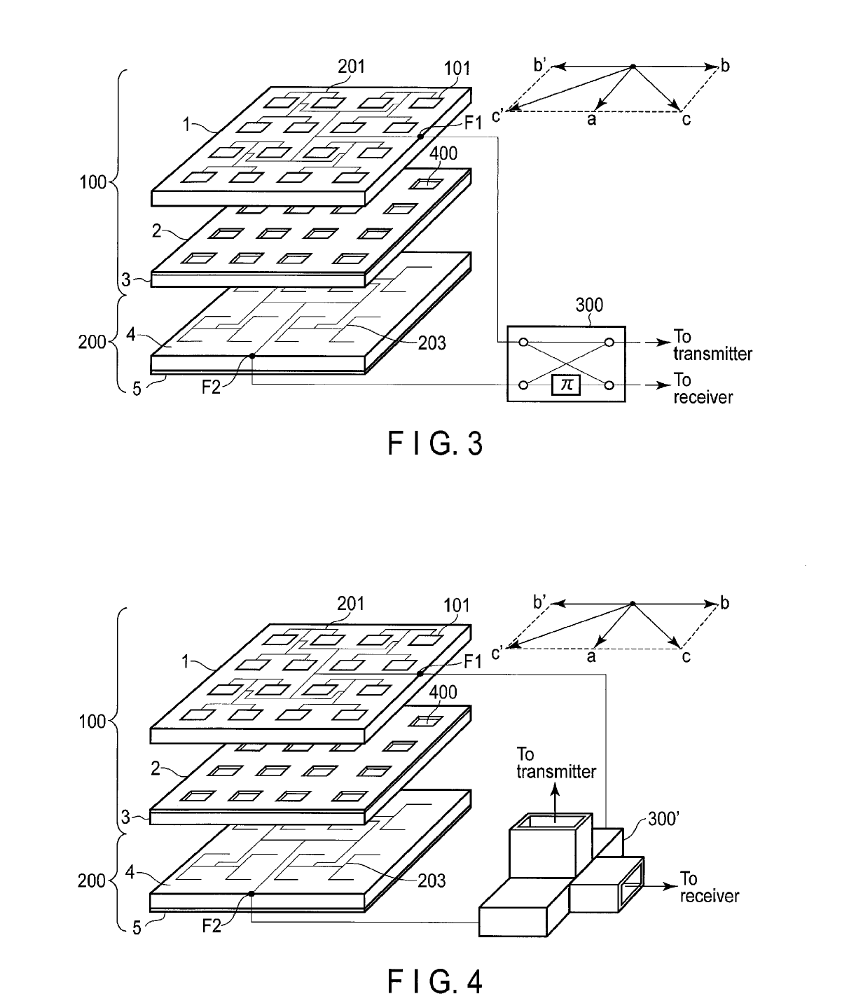

FIG. 3 shows an array antenna device of a second embodiment. The array antenna device of the second embodiment is different from the first embodiment in that the second radiating elements 102 are not formed on the second substrate 200 and, for example, a pattern of third feed lines 203 is designed to have feed ends extended under the centers of the first radiating elements 101 formed on the first dielectric layer 1, respectively, such that they are electromagnetically coupled under the first radiating elements 101. It should be noted that the feed ends of the third feed lines 203 are not necessarily provided under the centers of the first radiating elements 101, for example, as long as they are located under the first radiating elements 101. The third feed lines 203 connect the second feed point to the first radiating elements by a pattern of lines of equal length, which is the same as the pattern of the first feed lines 201, respectively, to form a linearly polarized wave in the second polarization direction orthogonal to the first polarization direction. It should be noted that “a pattern of lines of equal length, which is the same as the pattern of the first feed lines 201” does not necessarily mean that the third feed lines 203 are exactly the same as the first feed lines 201. For example, the third feed lines 203 may have a pattern obtained by rotating the pattern of the first feed lines 201 90°. As described above, the feed ends of the third feed lines 203 will do as long as they are located under the first radiating element 101. By this structure, since the first radiating elements 101 are fed in directions orthogonal to each other from the first feed lines 201 and the third feed lines 203, it is possible to output a polarized wave in the first direction and a polarized wave in the second direction orthogonal to the first direction from the first radiating element array.

FIG. 4 shows a case of using the waveguide type magic-T phase feed circuit 300′ as the 180° hybrid circuit 300 in the array antenna device of the second embodiment. In the same manner as the array antenna device of the first embodiment, the magic-T phase feed circuit may be either the waveguide type magic-T phase feed circuit 300′ or a magic-T phase feed circuit that can be formed on a substrate using a microstrip line and a slot line. Various well-known magic-T phase feed circuits can be used in place of the magic-T phase feed circuit as appropriate.

The array antenna device of the second embodiment having the above structure operates in the same manner as the array antenna device of the first embodiment.

That is, the array antenna device of the second embodiment can radiate a polarized wave having a plane of vibration at an angle of 45° with respect to the connection direction of the feed lines to the radiating elements. In other words, the feed lines can be connected or coupled to the radiating elements in the direction at an angle of 45° with respect to the direction of the plane of vibration of the radiated polarized wave. Therefore, for example, in the case where each radiating element is rectangular, a linearly polarized wave at a desired angle can be radiated without forming the radiating elements at an angle of 45° on the surface of the dielectric layer.

Furthermore, intervals between the radiating elements can be reduced in comparison with the case of forming rectangular radiating elements at an angle of 45° with respect to the substrates. Moreover, sufficient space to form lines can be provided without reducing intervals between the radiating elements in comparison with the case of forming rectangular radiating elements at an angle of 45° with respect to the substrates.

In addition, the array antenna device of the second embodiment can change a direction of a plane of vibration of a polarized wave depending on whether it is used for transmission or reception by interchanging the terminals of the 180° hybrid circuit 300 or 300′ connecting with the transmitter and the receiver. Therefore, the array antenna device of the second embodiment can easily switch the polarization direction even if the antenna is large in size and difficult to rotate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An array antenna device comprising:
a first substrate comprising a first feed point;
a second substrate provided under the first substrate and comprising a second feed point; and
a 180° hybrid circuit which feeds the first feed point and the second feed point with a phase difference of zero or 180°,
wherein the first substrate comprises:
a first dielectric layer;
a first radiating element array formed by arranging first radiating elements in an array on the first dielectric layer;
first feed lines provided on the first dielectric layer and connecting the first feed point to the first radiating elements by a pattern of lines of equal length, respectively, such that the first radiating elements form a linearly polarized wave in a first polarization direction;
a first ground conductor layer provided under the first dielectric layer; and
a second dielectric layer provided under the first ground conductor layer,
the second substrate comprises:
a third dielectric layer located under the second dielectric layer;
a second radiating element array formed by arranging second radiating elements in an array on the third dielectric layer such that the second radiating elements are opposed to the first radiating elements, respectively;
second feed lines provided on the third dielectric layer and connecting the second feed point to the second radiating elements by a pattern of lines of equal length, which is the same as the pattern of the first feed lines, respectively, such that the second radiating elements form a linearly polarized wave in a second polarization direction orthogonal to the first polarization direction; and
a second ground conductor layer provided under the third dielectric layer,
the first ground conductor layer has openings in positions opposed to the first radiating elements and the second radiating elements, and
connecting portions of the first feed lines to the first radiating elements are formed in a direction orthogonal to a direction of connecting portions of the second feed lines to the second radiating elements.

2. The array antenna device of claim 1, wherein
the first feed lines and the second feed lines are formed in a branching layout.

3. The array antenna device of claim 1, wherein
the 180° hybrid circuit is a magic-T circuit.

4. The array antenna device of claim 1, wherein
the 180° hybrid circuit comprises:
a first line which makes a phase difference of zero between the first feed point and the second feed point;
a second line which makes a phase difference of 180° between the first feed point and the second feed point; and
a switching unit which selectively switch between the first line and the second line.

5. An array antenna device comprising:
a first substrate comprising a first feed point;
a second substrate provided under the first substrate and comprising a second feed point; and
a 180° hybrid circuit which feeds the first feed point and the second feed point with a phase difference of zero or 180°,
wherein the first substrate comprises:
a first dielectric layer;
a first radiating element array formed by arranging first radiating elements in an array on the first dielectric layer;
first feed lines provided on the first dielectric layer and connecting the first feed point to the first radiating elements by a pattern of lines of equal length, respectively, such that the first radiating elements form a linearly polarized wave in a first polarization direction;
a first ground conductor layer provided under the first dielectric layer; and
a second dielectric layer provided under the first ground conductor layer,
the second substrate comprises:
a third dielectric layer located under the second dielectric layer;
second feed lines provided on the third dielectric layer, connecting the second feed point to the first radiating elements by a pattern of lines of equal length, which is the same as the pattern of the first feed lines, respectively, such that the first radiating elements form a linearly polarized wave in a second polarization direction orthogonal to the first polarization direction, and comprising feed ends extended under the first radiating elements; and
a second ground conductor layer provided under the third dielectric layer,
the first ground conductor layer has openings in positions opposed to the first radiating elements, and
connecting portions of the first feed lines to the first radiating elements are formed in a direction orthogonal to a direction of connecting portions of the second feed lines to the first radiating elements.

6. The array antenna device of claim 5, wherein
the first feed lines and the second feed lines are formed in a branching layout.

7. The array antenna device of claim 5, wherein
the 180° hybrid circuit is a magic-T circuit.

8. The array antenna device of claim 5, wherein
the 180° hybrid circuit comprises:
a first line which makes a phase difference of zero between the first feed point and the second feed point;
a second line which makes a phase difference of 180° between the first feed point and the second feed point; and
a switching unit which selectively switch between the first line and the second line.

9. The array antenna device of claim 5, wherein
the feed ends of the second feed lines are extended under centers of the first radiating elements.
